(19) United States
(12) Patent Application Publication
(10) Pub. No.: US 2005/0147917 A1
(43) Pub. Date: Jul. 7, 2005

(54) Etching resist precursor compound, fabrication method of circuit board using the same and circuit board

(76) Inventor: Yoshihide Yamaguchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/008,267

(22) Filed: Dec. 10, 2004

(30) Foreign Application Priority Data
Dec. 12, 2003 (JP) 2003-415558

(51) Int. Cl. G03C 1/76

(52) U.S. Cl. 430/270.1; 430/5

(57) ABSTRACT

The fabricating method of a circuit board by the present invention draws a desired pattern of an etching resist endurable to form a fine wiring on the circuit board by a paste sintered on a substrate by performing the steps in order of (a) fabricating the paste (etching resist precursor compound) comprising a superfine metal particle having an average particle size of 1 to 10 nm coated by an organic coating compound having a film thickness of 1 to 10 nm, a latent curing organic compound reacting to the superfine metal particle in the range of 100 to 250° C., and a dispersion medium capable of stably dispersing these components, (b) transferring this paste on a substrate by either of a relief printing, an intaglio printing, an offset printing, or a screen printing, and (c) sintering the paste by heating this substrate to 100 to 250° C.

### CROSS-REFERENCE TO APPLICATION

The present application claims priority from Japanese Patent Application No. JP 2003-415558 filed on Dec. 12, 2003, the content of which is hereby incorporated by reference into this application.

### TECHNICAL FIELD OF THE INVENTION

The present invention relates to a technology of a printing circuit, and in particular, it relates to a fabricating method of a circuit board at a low cost and in a short time, an etching resist precursor compound using the same, and a circuit board.

### BACKGROUND OF THE INVENTION

As a multilayer circuit board fabrication method, a large variety of methods have been designed, and the methods can be classified from several points of view and used properly in accord with their characteristics.

For example, to classify the printed circuit board with focusing on the conductor portion forming methods, the methods can fall into two broad general categories: (1) subtractive method in which a conductor is formed on the whole surface and undesired conductor portions are removed by etching while only desired conductor portions leaving and (2) additive method in which conductor patterns are formed only on the desired portions by the use of method such as plating and others.

Recently, considerable high-density wiring has been required for circuit boards used for various electronic equipments, and even when either of the above-mentioned methods is used, it has become a common practice to form a desired conductive pattern by using a photolithography suitable to form fine patterns.

The circuit board fabrication technology using photolithography is briefly described as follows.

In the case of the subtractive method, first of all, a substrate with a conductor formed on the surface is prepared, and on the surface, a coating of photosensitive material (resist, e.g. photoresist) is formed. Thereafter, the resist is processed into a desired pattern by exposure and development, and using the pattern as a mask, the substrate surface conductors located at the pattern opening portions are selectively removed by etching, and finally, the desired conductor pattern is obtained by removing the resist.

On the other hand, by the additive method, the photosensitive material (resist) filmed on the substrate surface is processed into desired patterns by exposing and developing, and then, with the pattern used as a mask, a conductor is formed in accordance with the resist opening pattern by a method such as plating and others, and finally, the desired conductor pattern is obtained by removing the resist.

Whether the subtractive method is used or the additive method is used, the use of the photolithography technology using photosensitive material enables fine high-density circuit patterns to be comparatively easily formed only by preparing photo masks corresponding to the desired patterns.

However, because the above-mentioned conventional technologies utilize photolithography, the technologies have technical problems specific to photolithography as mentioned below.

(1) It takes long time to begin production after completion of designing circuit patterns:

Fabrication of the photo mask used in the photolithography technology can be started only after desired circuit patterns are designed using CAD (Computer Aided Design) and others and after the data is further converted into processing data of the photo mask fabrication apparatus (photo plotter). According to the fact that substrate fabrication cannot be started unless the photo mask is ready, a period from several days up to one week required to fabricate the photo mask after-undergoing these complicated processes causes obstacles for shortening of the fabrication lead time.

(2) Photo masks must be fabricated in each time when the design is changed:

Even in the case of minor design changes such as modifying only slight part of the circuit patterns, the photo mask must be completely newly fabricated, and the substrate fabrication must be suspended in each time until refabrication of the photo mask is completed, which generates vain wait time.

Because in analog signal processing circuits, unexpected malfunction is likely to occur due to noise from peripheral circuits, adjustments of patterns after product assembly (cut-and-try) are frequently carried out, and the occurring of troublesome works for re-fabricating the photo mask per such adjustments constitutes one of the reasons for prolonged period of developments.

(3) Photo masks must be redundantly fabricated for each fabricating site:

The pattern size on the photo mask is, in general, not exactly same as the pattern size on the design drawing but correction specific to a fabricating line is frequently made. Specifically, the pattern size and profile are corrected with performance and accuracy of various kinds of processing apparatus and equipment (for example, parallelism, wavelength, and aberration of light source in photolithography machine, in-plane distribution of film quality and, temperature distribution in film-forming apparatus, and others) taken into account.

Consequently, even when exactly same products (circuit boards) are manufactured, the photo mask cannot be accommodated among a plurality of fabricating sites, and in order to achieve shared production among sites, photo masks must be fabricated at every fabricating site, causing obstacles to flexible production adjustment.

On the other hand, presently, various information equipments including cellular phones, personal computers, and others are distributed to the public, and a tendency for one person to possess one (or more) of these information equipments is much more strongly developed, and a wide variety of functions and performance that support a wide variety of use environment and use condition of each individual have been required. To satisfy these diverse needs, the production system of “mass-producing single specification products” cannot accommodate, and a high-variety small-lot production and a fabricating system that can adjust the production amount and production sites in accord with demand fluctuation are desired.

In order to solve the problems (1) through (3) above, which constitute big obstacles to these market needs, a technology for selectively irradiate the desired portion only of the resist without using photo masks has been proposed and for example, as exemplified in Japanese Patent Application Laid-Open Publication No. 2003-195511 (and its corresponding U.S. Patent Application Publication U.S. 2003/0124463A1), this is called a direct drawing technology, and is a technique to scan-irradiate the resist surface with a laser beam in place of using photo masks (first conventional technology).

Because in the first conventional technology, no photo mask is used, problems described in Paragraphs (1) through (3) can be solved. However, the laser scan apparatus used in this technology requires large-scale equipment with data processing apparatus to quickly process very large amounts of drawing data combined in addition to the laser light source and complicated optical system, and a new problem of high cost and large consumption energy is generated.

In the mean time, in Japanese Patent Application Laid-Open Publications Nos. 56-66089, 56-157089 and 58-50794 a technique to form resist patterns using an ink jet printing technique in place of photolithography represented by exposure and development of photosensitive material is proposed (second conventional technology). The feature of this technique lies in that chemical-resistant resin ink (resist) is directly drawn on a substrate, and a process for applying the resist to the whole surface and a process for removing resist at undesired portions are no longer required.

As a result, by (1) reduction of photoresist consumption amount, (2) non-use of developer, and (3) shortened fabricating time resulting from omission of processes, reduction of the fabricating cost can be achieved, too. Because the ink jet printing apparatus requires no complicated optical system or no power supply for laser emission, as compared to the laser-scan apparatus used in the first conventional technology, comparatively lower cost and less power consumption can be achieved.

While ink bleed and instability of ink shape are likely to occur in the ink jet printing technology, a countermeasure technique to specify the surface roughness range of the substrate for such phenomena is proposed in Japanese Patent Application Laid-Open Publication No. 8-242060.

### SUMMARY OF THE INVENTION

When fine wiring is formed by the use of the second conventional technology, low-viscosity ink is used to discharge (eject) superfine ink drops accurately by ink-jet printing, and as a result, the resist becomes a very thin film thickness by one drawing, and there is a problem that it is unable to endure a desired plating step or an etching step, thereby causing a peeling off or a crack of resist.

To solve this problem, though there is a method available, which forms a resist pattern having a thickness capable of enduring the plating step or the etching step by recoating plural times, there is a problem that it takes a long period of time to form a film in addition to the fact that the ink bleed and instability of ink shape occurs. As described above, in Japanese Patent Application Laid-Open Publication No. 8-242060, to cope with the problem of the ink bleed and instability of ink shape, there has been proposed a technology to limit a degree of surface roughness range of the substrate (conductor). However, this does not give a solution to the problem of taking a long period of time to form a film.

Further, since a degree of conductor surface roughness widely affects an adhesion of resist, when the degree of surface roughness range is limited as a counter measure for the ink bleed and instability of ink shape, the adhesion of the resist cannot be maintained, and a peeling off or a crack of the resist occurs while in the process of being plating and etching steps, and eventually, it does not endure the plating step or the etching step.

In addition, because superfine accurate shaping of ink discharge port (i.e. ink jet nozzle) is essential to accurately discharge superfine ink droplets by ink jet printing, it is difficult to obtain the ink discharge port. Furthermore, in order to efficiently form resist film in a wide area by superfine ink droplets, it is desirable to arrange a large number of highly accurate ink discharge ports in a line, but the inkjet printer that has such a large number of juxtaposed highly accurate ink discharge ports inevitably costs high, and the printer can not solve the problem of the first conventional technology concerning the apparatus price.

An object of the present invention is to solve the problem in the second conventional technology.

To be more specific, a first object of the present invention is to provide a technology which performs a deposition of the resist being high in adhesion by a printing method in such a manner as to solve a first problem (occurrence of a peeling off and a crack of the resist) in the second conventional technology.

A second object of the present invention is to provide a technology to deposit the resist at a high speed and effectively either in a wide region such as a grand wiring or a micro region such as a signal wiring.

Further, it is also an object of the present invention to provide a low cost circuit board which can be fabricated in a short delivery time by a direct drawing of the resist.

To achieve the above described objects, the inventor of the present application has conceived a technology which is compatible with both resist adhesion and high speed deposition by making a printing deposition of a matter forming a metallic bond for a metal to become a wiring conductor, and further has conceived a fabricating method of the circuit board at a low cost and at a short lead time by the above described technology, thereby carrying out the present invention.

The characteristics of the technology (technological means) of the present invention are as follows.

An etching resist precursor compound of the present invention is characterizing by comprising (a) a superfine metal particle having an average particle size of 1 to 10 nm, (b) an organic coating compound coated on the surface of the superfine metal particle with a film thickness of 1 to 10 nm, (c) a latent curing organic compound reacting to the organic coating compound in the range of 100 to 250° C., and (d) a dispersion medium capable of stably dispersing the components (a) to (c) therein, which can be sintered at temperatures below 250° C.

The fabricating method of the present invention is characterized by including the steps of: (a) fabricating a paste of the etching resist precursor compound which contains the superfine metal particle having an average particle size of 1 to 10 nm, the organic coating compound coated on the surface of the superfine metal particle with a film thickness of 1 to 100 nm, the latent curing organic compound reacting to the organic coating compound in the range of 100 to 250° C., and the dispersion medium capable of stably dispersing these components therein, (b) transferring the paste on a substrate by using a printing technology selected from either of a relief printing, an intaglio printing, an offset printing, and a stencil printing, and (c) after that, making an etching resist having a desired pattern shape by sintering the paste by heating the substrate at 100 to 250° C.

The circuit board of the present invention is characterized in that a predetermined wiring conductive pattern is formed by etching a conductive metal with an etching resist as a mask in which a metallic dispersion state is formed with the conductive metal on a substrate. The circuit board is characterized in that the etching resist comprises a metallic particle which performs a mutual dispersion with the conductive metal or a dispersion to the conductive metal, and is formed by sintering the etching resist precursor compound, which becomes an etching resist by sintering, on the conductive metal.

The etching resist is characterized by being formed by sintering on the conductive metal on the substrate the etching resist precursor compound comprising (a) a superfine metal particle having an average particle size of 1 to 10 nm, (b) an organic coating compound coated on the surface of the superfine metal particle with a film thickness of 1 to 10 nm, (c) a latent curing organic compound reacting to the organic coating compound in the range of 100 to 250° C., and (d) a dispersion medium capable of stably dispersing therein three parties of the superfine metal particle, the organic coating compound, and the latent curing organic compound.

The circuit board of the present invention is characterized in that, when the conductive metal is subjected to an etching processing so as to form an wiring conductive pattern, it is used as a mask, and moreover, the etching resist which is metal-bonded with the wiring conductor is left over the wiring conductive pattern. The etching resist is characterized by being formed by sintering on the conductive metal on the substrate the etching resist precursor compound comprising (a) a superfine metal particle having an average particle size of 1 to 10 nm, (b) an organic coating compound coated on the surface of the superfine metal particle with a film thickness of 1 to 10 nm, (c) a latent curing organic compound reacting to the organic coating compound in the range of 100 to 250° C., and (d) a dispersion medium capable of stably dispersing therein three parties of the superfine metal particle, the organic coating compound, and the latent curing organic compound.

The circuit board of the present invention is characterized by being used as a mask in a bonded state with the conductive metal when the conductive metal is subjected to an etching processing so as to form an wiring conductive pattern, and after being used as a mask, being fabricated by using an etching resist having a conductivity capable of remaining on the conductive metal. The etching resist is characterized by being formed by assuming a desired pattern on the conductive metal by sintering the desired pattern drawn on the conductive metal by (3) the etching resist precursor compound prepared by diffusing into a dispersion medium (1) a nano particle formed by coating the organic coating compound on the surface of the superfine metal particle with a film thickness of 1 to 10 nm, and (2) the latent curing organic compound reacting to the organic coating compound in the range of 100 to 250° C. The superfine metal particle has an average particle size of 1 to 10 nm.

According to the technology proposed by the present invention, the following advantages can be achieved.

(1) Since a matter forming a metallic bond for the metal which becomes a wiring conductor is taken as a resist, a required thickness of the resist may be thin. Since the resist is thin, a micro processing of the resist becomes easy, and in addition, a flow property of etching solution becomes excellent, and a desired fine pattern can be formed without resort to the photolithography.

(2) Since the etching processing of the conductive metal can be performed with a resist having a thin film thickness as a mask, a rectangular property of the sectional form of the conductor formed by the etching processing can be enhanced, so that the securing of a bonding area in a wiring portion and a reduction in conductive resistance can be attempted.

(3) Since the pattern of the resist precursor compound capable of being sintered at low temperatures is directly drawn on the substrate, the wiring can be fabricated in a short time and at a low cost. A resist developing solution is not required, and the amount of capital investment such as a photo exposure machine, a developing machine, and the like can be minimized.

### BRIEF DESCRIPTIONS OF THE DRAWINGS

FIG. 1 is a conceptual diagram schematically showing one example of the configuration of an etching resist precursor compound according to the present invention; and

FIGS. 2A to 2E are process schematic diagrams specifically illustrating one example of the fabrication method of a circuit board comprising a fine wiring proposed by the present invention.

### DESCRIPTION OF THE PREFERRED EMBODIMENTS

The best mode of carrying out the present invention will be described below appropriately with reference to the drawings.

### First Embodiment

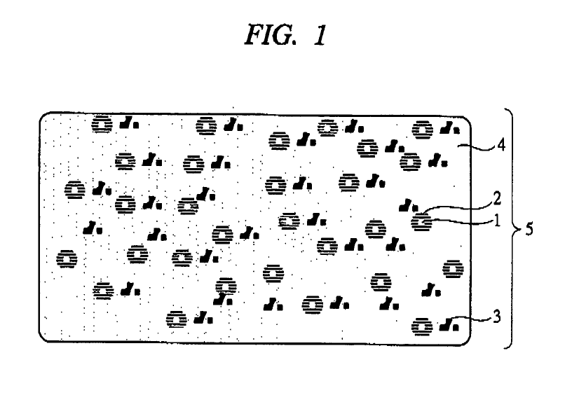

In a first embodiment, an etching resist precursor compound (and a composition thereof) which is one of the technologies proposed by the present invention will be described. FIG. 1 is a conceptual diagram schematically showing one example of the configuration of the etching resist compound according to the present invention.

As shown in FIG. 1, the etching resist precursor compound according to the present invention contains (a) a superfine metal particle (metal nanoparticle) 1 having an average particle size of 1 to 10 nm, (b) an organic coating compound 2 coating the superfine metal particle 1 with a film thickness of 1 to 10 nm, (c) a latent curing organic compound 3 reacting to the organic coating compound 2, and (d) a dispersion medium 4 capable of stably dispersing the components of (a) to (c).

A superfine metal particle 1 suitable to the present invention is a so-called metal nanoparticle having an average particle size of 1 to 10 nm. In the present invention, the metallic type of the metallic nanoparticle will be decided by taking into consideration the following items.

That is, it is taken into consideration that (1) whether or not the metallic type of the metal nanoparticle forms a strong metallic bond with a wiring conductive metal, (2) whether or not the metallic type of the metallic nanoparticle forms a metallic film having an etching tolerance, and (3) whether or not an intermetallic compound formed between the metallic type of the metal nanoparticle and the wiring conductive metal has an etching tolerance.

As such a metallic type, to be more specific, for example, silver, platinum, palladium, tin, lead, nickel, and the like can be cited.

In order to prevent the superfine metal particles 1 from being aggregated one another, the organic coating compound 2 is allowed to adhere to the surface in advance. If the surface of the superfine metal particles 1 is not covered with such organic compound, the superfine metal particles 1 collide one another by thermal motion (Brownian motion) in dispersion medium 4, and by this, multiple superfine metal particles 1 coagulate. In the present invention, in order to prevent aggregation of this superfine metal particle, the surface of individual superfine metal particle 1 is covered with a layer that forms a so-called “cushion.” The layer functioning as a cushion is formed by an organic compound 2 having properties to spread in a form of layer throughout the surface of the superfine metal particle 1, that is, “organic coating compound” in order to suppress aggregation even by any collisions between superfine metal particles 1. In the present invention, the film thickness of the organic coating compound 2 that coats the surface of the superfine metal particle 1 is preferably between 1 and 10 nm.

In the present invention, since the coated film is allowed to spontaneously form on the surface of the superfine metal particle 1 through the self-assemble mechanism of the organic coating compound 2, the upper limit of the practical film thickness that can be formed by the mechanism is the most suitable film thickness of the present invention. In addition, the thickness of the film in which aggregation avoidance effect of the superfine metallic particle 1 by the organic coating compound 2 is fully obtained is defined as the lower limit of the most desirable film thickness in the present invention. That is, it is preferable to set the film thickness of the coated organic compound 2 that adheres to the surface of the superfine metal particle 1 to a range between not less than 1 nm and not more than 10 nm. Meanwhile, the particles which are coated by the organic coating compound 2 of 1-10 nm thickness are nanoparticles whose particle size is between 3 and 30 nm.

In the present invention, it is preferable to provide the organic coating compound 2 with coordination to the above metals so that the coated film does not come off from the surface of the superfine metal particles 1 while the etching resist precursor compound 5 is stored. By coordinate-bonding the organic compound 2 to the metal atoms forming the superfine metal particles 1, the layer of the organic compound 2 spreads over the surface of the superfine metal particles 1 and becomes difficult to come off. In the present invention, publicly known conventional coordination compounds can be used as the organic coating compound 2, and this organic coating compound 2 is preferably Lewis base (electron donor) which has non-bonding electron pairs. The coordinate bond of organic compounds with Lewis base to metal atoms depends on the acidity and hardness of acid of the metal atom as Lewis acid (electron acceptor) and on the transfer speed of the organic compound. For specific examples of such organic coating compound, primary or secondary amines, polyether, and others are suitably shown for coordinate-bonding to metals.

More detailed examples of typical compounds of the organic coating compound include diisopropylamaine and trioxane. However, these substances are merely exemplified as substances which can be used as the organic coating compound in the present invention, and needless to say, it is no need to limit the organic coating compound to such substances.

In the present invention, while the organic coating compound 2 is allowed to spontaneously aggregate (self-assemble) on the surface of the superfine metal particles 1, reactions of organic coating compound to self-assemble on the surface of superfine metal particles 1 and reactions of superfine metal particles 1 to coagulate and aggregate competitively occur. Because the nanosize effect later discussed is lost when superfine metal particles 1 coagulate and aggregate, it is preferable to use the organic coating compound 2 with a large self-assemble reaction speed.

The present inventor found out that the speed of self-assemble reaction of the organic coating compound 2 is greatly influenced to the mass transfer in the liquid in which the compound is dispersed (for example, dispersion medium 4), and chose the Lewis base which provides a large transfer speed in the dispersion medium 4 later discussed as the organic coating element. Or, the etching resist precursor compound 5 may be mixed and prepared under the conditions to accelerate the transfer speed of the organic coating element. By the way, it is needless to point out again that the self-assemble speed of the organic coating compound 2 is not determined only by the transfer speed of the medium and the transfer speed in the medium is determined by various factors.

The organic coating compound 2 suited for the present invention is the Lewis base which has the donation number, which is an index of the intensity of interaction with the dispersion medium 4, between 0 and 14 and the molecular weight between 50 and 2000, with the availability taken into account.

Meanwhile, because the hardness of acid varies in accordance with the kind of metal, particle size, and others of the superfine metal particles 1, the Lewis base having hardness corresponding to the hardness of acid of superfine metal particles 1 should be preferably used as the organic coating compound 2, and a compound in which the basicity and nucleophilicity are well-balanced should be most suitably used.

By these innovations, the above described film does not peel off from the surface of the superfine metal particle 1 while the etching resist precursor compound 5 is stored. However, it is necessary to peel off the above described film from the surface of the superfine metal particle 1 prior to forming the etching resist from this compound (etching resist precursor compound 5), and in the present invention, the compound (latent curing organic compound 3) having a latent ability reacting to the organic coating compound 2 constituting the coated film is mixed.

The latent curing organic compound 3 is chosen from publicly know conventional substances which react with the organic coating compound 2, but a substance which exhibits the “latent reactivity” that does not react during storage but begins reactions when a specific external stimulus is given is preferable.

Specific examples include (1) substances which are solid at room temperature and scarcely reactive but manifest reactivity due to dissolution thereof to medium or melting thereof by application heat thereto; (2) substances which give rise to decomposition or rearrangement reactions and obtain a reactive functional group when they are heated to a specified temperature or higher; (3) substances which cause decomposition or rearrangement reactions and obtain a reactive functional group by optical stimulus of specific wavelength, and others.

In the present invention, with convenience of facilities and process in circuit board fabrication process taken into account, the heating treatment of the etching resist precursor compound 5 is judged the best suited as the “specific external stimulus,” and the latent curing organic compound 3 which actualizes the reactivity or acquires reactivity by heating treatment at 100-250° C. is used.

Examples of the latent curing organic compound 3 suited for the present invention include tetraethylammonium-tetrafluoroborate, triphenylphosphine, and others, but these substances are absolutely shown as examples and needless to say, the latent curing organic compound 3 should not be limited to these substances.

Meanwhile, it is allowable to add a latency supplementing component to the etching resist precursor compound 5 as required in order to assist or augment the latency. For example, substances which decompose by heat and light and generate acid or base may be added. Specific examples include ammonium salts which generate acid by Hofmann decomposition by heat and sulfonium salts which generate acid by photodecomposition, and in the present invention, it is desirable to add these supplementary components in a range that would not interfere with the stable dispersibility of the etching resist precursor compound 5.

The latent curing organic compound 3 of the present invention undergoes nucleophilic reactions from the nucleophilic substituent group of organic coating compound 2. Consequently, with regard to suitable organic coating compound 2 and latent curing organic compound 3 in the present invention, it is preferable to appropriately choose combinations suited for intended use with the reactivity of them taken into account.

The most suitable combination in the present invention is the combination of strong basic organic coating compound 2 with weak nucelophilicity and weak acidic latent curing organic compound 3 with weak or medium electrophilicity.

In the present invention, a dispersion medium 4 is used in order to stably disperse the three components of superfine metal particles 1 (metal nanoparticle), organic coating compound 2, and latent curing organic compound 3. For the dispersion medium 4, publicly known conventional organic medium can be used, but a medium which secures stable dispersibility with superfine metal particles 1 after achieving suitable reactivity between organic coating compound 2 and latent curing organic compound 3 is preferable.

From the viewpoint of achieving appropriate reactivity, the dispersion medium 4 preferably possesses specific physicochemical properties. Examples of the suitable specific physicochemical properties in the present invention include solubility parameter, viscosity, surface tension, dielectric constant, and others. According to experiments of the present inventor, the specific value of solubility parameter δ of the dispersion medium 4 suited for the present invention was between 2.5 and 7.0. Meanwhile, needless to say, several kinds of medium can be used in combination or even a medium that exceeds the above-mentioned solubility parameter may not always be used depending on the property values of viscosity, dielectric constant, and others.

In the present invention, for the solubility parameter of the medium, a numerical value which can be obtained by the publicly known conventional calculation formula, that is, by dividing the evaporation enthalpy ΔH of the liquid molecule by molecular weight and then raising the quotient to the ½ power, is used.

The paste composition of the present invention contains superfine metal particles 1 which combine a hydrophobic property by coating the surface with the organic coating compound 2 and latent curing organic compound 3. In order to stably disperse both, the present inventor was dedicated to searching the dispersion medium and found that one of the key properties for stable dispersion is the polarity of the dispersion medium.

When the present inventor investigated the dispersion stability with the solubility parameter used as an index, the present inventor confirmed that a paste comparatively stably dispersed is likely to be obtained if the solubility parameter δ is between 2.5 and 7.0 as described above.

Meanwhile, because as self-apparent from the calculation formula, the solubility parameter is an index that shows the extent of polarity per unit volume of the solvent, it is assumed that hydrophobicity excessively increases as the solubility parameter becomes smaller than 2.5 and superfine metal particles 1 which provide partially hydrophobicity is likely to aggregate.

### Second Embodiment

In the present second embodiment, the fabrication method of a circuit board and the circuit board thereof by utilizing the etching resist precursor compound according to the present invention as described in the first embodiment will be described.

First, the fabrication method of the circuit board utilizing the etching resist precursor compound 5 proposed by the present invention will be described. By using the etching resist precursor compound 5 according to the present invention, a fine wiring pattern formation can be easily realized, and therefore, the circuit board comprising a fine wiring can be fabricated at a low cost and in a short time by using this fine wiring pattern forming method at least for a portion thereof.

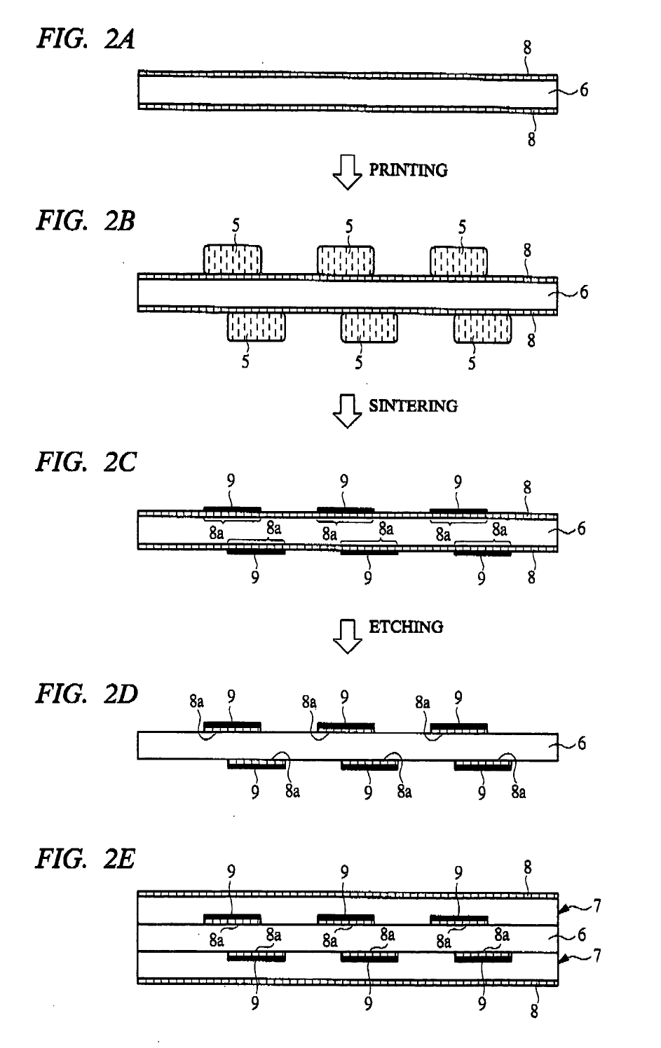

FIGS. 2A to 2E are process block diagrams specifically illustrating along a processing procedure one example of the fabricating method of the circuit board comprising the fine wiring proposed by the present invention.

FIG. 2A shows a base member 6, which becomes a base of the circuit board. As shown in FIG. 2B, the etching resist precursor compound 5 is deposited on the surface of the base member 6 in such a way to become a desired pattern form. As shown in FIG. 2C, after subjecting the pattern portion to heat treatment so as to sinter, as shown in FIG. 2D, by subjecting it to an etching processing, it becomes a fine wiring having a desired pattern. After that, to be multi-layered until reaching the number of desired layers, as shown in FIG. 2E, a resin copper foil 7 is adhered on it, and after that, the operations of FIGS. 2B to 2B may be repeated or a package lamination together with other substrates may be performed as occasion demands.

Each operation of FIGS. 2A to 2E will be described in detail below.

First, as shown in FIG. 2A, the base member 6 is prepared, which forms in advance a conductor 8 such as a copper foil subjected to a pattern etching at an etching step (to be described later). Here, though illustrated is a double face copper-clad substrate, which can be acquired in a form adhered in advance with a copper foil at both faces, a know conventional other substrate, for example, a single side copper-clad substrate may be also used, and needless to mention, it may be fabricated by own by adhering the conductor 8 on an insulated substrate.

Next, as shown in FIG. 2B, the etching resist precursor compound 5 is deposited in the form of a pattern on the conductor 8 existing on the surface of the base member 6. In the present invention, for the pattern formation of the etching resist precursor compound 5, instead of a photolithography technology, a printing technology is used. In the present invention, though it is possible to form a pattern by using a known conventional printing technology, the printing technology selected from either one of a relief printing, an intaglio printing, an offset printing, and a screen printing is desirable. A particularly suitable printing technology is the screen printing, and among them, the screen printing and the stencil printing are particularly suitable.

The present invention is characterized in that at least a part of the wiring pattern is formed not by the photolithography, but by the printing technology, and due to this characteristic, a selective correction can be simply executed on the pattern only of a desired place on the circuit board. Further, needless to mention, the use of the superfine particle having an average particle size of 1 to 10 nm makes it possible to form a fine wiring such as falling below a wiring width of 1 μm. On the contrary, when the particle having a particle size exceeding 10 nm which is the upper limit of the present invention is used, not only a nanosize effect is not acquired, but a fine wire extent that can be formed by the printing becomes also inevitably wide.

In the present invention, publicly known conventional printing mask can be used, but when fine patterns are formed, particular care is required for the condition of the printing mask opening portion. Because the transfer rate of the etching resist precursor compound 5 is subject to a gauze exposed to the mask opening portion, a metal mask with no gauze exposed at the opening portion is desirable, if possible. It is not necessary to point out but at the time of installing a metal mask to the mask frame, a so-called combination mask with a gauze portion installed around the metal mask may be used.

FIG. 2C shows a sintering step of the etching resist precursor compound 5 having a desired pattern form. In the present invention, the etching resist precursor compound 5 having the pattern form and the base member 6 are subjected to heat treatment in the temperature range of 100 to 250° C., so that the etching resist precursor compound 5 is sintered on the conductor 8a (8) of the surface of the base member 6. As occasion demands, even when a method of selectively heating the pattern portion only is adapted, no particular problem arises. For example, as such a method, a direct spot heating by a laser beam and the like can be cited.

In the process of sintering, the superfine metal particle 1 (metal nanoparticle) is dissolved due to its nano effect, and at the same time, due to the reaction between the organic coating compound 2 and the latent curing organic compound 3, a reaction occurs that the organic coating compound 2 is removed from the surface of the superfine metal particle 1. Further, the superfine metal particle 1 in the dissolved state reacts to a metal of the conductor 8a existing on the surface of the base member 6, thereby forming either a metallic bond or an intermetallic compound. At that time, the superfine metal particle 1 disperses inside the metal of the base material 6 surface or is put into a state in which the superfine metal particle 1 and the base material surface metal are mutually dispersed, thereby securing a strong bond. In this way, the superfine metal particle 1 becomes a resist film 9 high in durability to the etching step and the plating step.

Next, as shown in FIG. 2D, the base member 6 in which the resist film 9 having a desired pattern form is deposited is subjected to the etching processing with the resist film 9 as a mask, so that the conductor 8 of the base member 6 surface is processed to a desired pattern. In the present invention, though a known conventional etching processing can be used, in due consideration of an etching selection ratio between the resist film 9 and the conductor 8, a composition of etching solution and an etching condition are set. Illustrating a specific example of the etching solution suitable to the present invention, there are, for example, the etching solution such as a mixture of ammonium chloride and ammonia, a mixture of sulfuric acid and sulfated hydrogen, and the like.

In the present invention, though the fine wiring for a double face one layer portion can be formed by the steps up to FIG. 2D, as occasion demands, a formation of multi-layer can be also realized by a known conventional method. A method of forming the multi-layer most suitable to the present invention, as shown in FIG. 2E, is to adopt a known conventional build-up substrate fabricating method after adhering the resin copper foil 7 on the fine wiring formed by the steps up to FIG. 2D. It goes without saying that adopting the multi-layer formation other than this method is also allowed.

Further, repeatedly using the operations of FIGS. 2B to 2D for the upper layer patterning causes no problem. By so doing, since the currently available circuit board fabrication facility can be appropriated, an immunization of capital investment and a leveling of capacity utilization ratio can be achieved.

Next, the circuit board fabricated by the fabrication method according to the present invention as described above will be described. In the circuit board fabricated by the fabrication method of the above descried circuit board, the resist film 9 used as a mask may be left as it is on the conductor 8. The resist film 9 is formed by sintering the above described etching resist precursor compound 5, and primarily has conductivity, and can be left on the conductor 8 as it is. Hence, comparing to the conventional technology, which is required to remove the resist used as a mask at the etching time without fail, such a step of removing the resist can be omitted, and by that much attempt to reduce the production cost, a low cost circuit board can be fabricated. Of course, as occasion demands, the resist film 9 may be removed without leaving it on the conductor 8.

According to the experiments of the present invention, in case the metallic type of the superfine metal particle 1 is either silver or silver alloy, using the circuit board in state where the resist film 9 is removed rather than using the circuit board in state where the resist film 9 is left as it is results in a favorable reliability. In the meantime, when tin is used, there is no difference of reliability observed regardless of leaving or removing the resist film 9, and when importance is attached to the perspective that omission of tin removing step leads to a low cost, the circuit board may be used without removing tin.

Further, as described above, since the resist film 9 forms a metallic bond with the conductor 8, it is different from a mask which does not form such a metallic bond and is composed of a conventional organic resin resist formed on the conductor 8 by physical adsorption, and is much harder to suffer from erosion by the etching solution and the like. Hence, comparing to the case of the subtractive method using the conventional organic resin resist, the resist film 9 can be formed markedly thin, and by that much, a circulation of the etching solution becomes better at the etching time, and a cross section of the conductor 8 formed by the etching becomes much closer to a rectangular form.

In case the conventional organic resin resist is used as a mask at the etching time, it is necessary to form a layer thickness thick in such a way as to not peel off at the etching processing time, and by that much, a better circulation of etching solution is not secured, and the cross section formed of the conductor is different from the circuit board according to the present invention, and has a form of splaying out from upper portion to the lower portion.

In the circuit board of the present invention, since the conductor cross section can be made closer to a rectangular form, and different from the previous circuit board, the conductor cross sectional area which becomes a wiring can be made increased, thereby making electrical resistance in the wiring much smaller.

Further, comparing to the splaying out cross sectional form adopting the prior art, a bonding area on the conductor surface can be secured wide, and a bonding error such as a wire bonding, a flip chip bonding and the like at the boding processing time can be removed, thereby realizing a circuit board having an excellent boding performance.

In the meantime, when the circuit board according to the present invention is compared to the circuit board fabricated by the additive method of the conventional technique, the following is revealed. That is, in case the conductor having a rectangular cross section is formed by adopting the additive method, the number of steps is so increased that the production cost thereof becomes high, and therefore reduction of the production cost achieved by the present invention cannot be expected.

Further, in the case of the additive method, regardless of the full additive method or the semi-additive method, a coplanarity of the conductor formed on the circuit board poses a problem. It is actually difficult to uniformly control the plating growth in the opening portion of the resist pattern across plural places of the circuit board, and since the plating growth becomes widely different by current density, the coplanarity in the conductor portion of the circuit board formed in this way is far inferior comparing to the circuit board of the present invention fabricated by subjecting the resist formed in a uniform film thickness to the etching processing.

The present invention can be effectively utilized in the field of the printing circuit. More in detail, it can be effectively utilized in the method of fabricating the circuit board at a low cost and in a short time and the field of the circuit board, and the like.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

1. An etching resist precursor compound, comprising (a) superfine metal particle having an average particle size of 1 to 10 nm, (b) an organic coating compound coated on a surface of said superfine metal particle with a film thickness of 1 to 10 nm, and (c) a latent curing organic compound reacting to the organic coating compound in a range of 100 to 250° C., and (d) a dispersion medium capable of stably dispersing the components (a) to (c), and the etching resist precursor compound being sintered at temperatures below 250° C.

2. A fabricating method of a circuit board, comprising the steps of: (a) preparing a paste of the etching resist precursor compound, comprising the superfine metal particle having an average particle size of 1 to 10 nm, an organic coating compound coated on a surface of the superfine metal particle with a film thickness of 1 to 10 nm, a latent curing organic compound reacting to the organic coating compound in a range of 100 to 250° C., and a dispersion medium capable of stably dispersing these components therein, (b) transferring the paste on the substrate by using a printing technology selected from either of a relief printing, an intaglio printing, an offset printing, and a stencil printing, and (c) after that, sintering the paste by heating the substrate to 100 to 250° C., thereby obtaining an etching resist having a desired pattern form.

3. A circuit board, wherein a predetermined wiring conductive pattern is formed by etching a conductive metal with an etching resist as a mask in which a metallic dispersion state is formed with the conductive metal on a substrate.

4. The circuit board according to claim 3, wherein the etching resist comprises a metallic particle which performs a mutual dispersion with the conductive metal or a dispersion to the conductive metal,
the circuit board being formed by sintering an etching resist precursor compound which becomes the etching resist by sintering on the conductive metal.

5. The circuit board according to claim 3, wherein the etching resist is formed by sintering on the conductive metal on the substrate the etching resist precursor compound, comprising:
(a) a superfine metal particle having an average particle size of 1 to 10 nm,
(b) an organic coating compound coated on a surface of the superfine metal particle with a film thickness of 1 to 10 nm,
(c) a latent curing organic compound reacting to the organic coating compound in a range of 100 to 250° C., and
(d) a dispersion medium capable of stably dispersing therein three parties of the superfine metal particle, the organic coating compound, and the latent curing organic compound.

6. A circuit board, wherein the etching resist, which is used as a mask when the conductive metal is subjected to the etching processing so as to form a wiring conductive pattern, and moreover, which is metal-bonded with the conductive metal, is left on the wiring conductive pattern.

7. The circuit board according to claim 6, wherein the etching resist is formed by sintering the etching resist precursor compound on the conductive metal on the substrate, comprising:
(a) a superfine metal particle having an average particle size of 1 to 10 nm,
(b) an organic coating compound coated on a surface of the superfine metal particle with a film thickness of 1 to 10 nm,
(c) a latent curing organic compound reacting to the organic coating compound in a range of 100 to 250° C., and
(d) a dispersion medium capable of stably dispersing therein three parties of the superfine metal particle, the organic coating compound, and the latent curing organic compound.

8. A circuit board, which is fabricated by using the etching resist having conductivity which is used as a mask in a bonded state with the conductive metal when the wiring conductive pattern is formed by the etching processing of the conductive metal and capable of remaining on the conductive metal after being used as the mask.

9. The circuit board according to claim 8, wherein the etching resist is formed by sintering on the conductive metal the etching resist precursor compound which disperses in the dispersion medium a nanoparticle coating the organic coating compound on the surface of the superfine metal particle with a film thickness of 1 to 10 nm and the latent curing organic compound reacting to the organic coating compound in a range of 100 to 250° C.

10. The circuit board according to claim 9, wherein the superfine metal particle has an average particle size of 1 to 10 nm.
